(19) United States
(12) Patent Application Publication
(10) Pub. No.: US 2002/0075299 A1
(43) Pub. Date: Jun. 20, 2002

(54) Persistent navigation assistance

(76) Inventors: Christopher M. Tobin, Central Valley, NY (US); Philip Michael Abram, Warwick, NY (US); Marc Beckwitt, San Clemente, CA (US); Gregory D. Gudorf, San Diego, CA (US); Kazuaki Iso, Oradell, NJ (US); Brian Raymond, San Diego, CA (US); Brian M. Siegel, Washingtonville, NY (US)

Correspondence Address: Christopher M. Tobin, Esq., Intellectual Property Department, Sony Electronics Inc., 123 Tice Boulevard - MD T1-1, Woodcliff Lake, NJ, 07677-8402, US

(21) Appl. No.: 09/873,067

(22) Filed: Jun. 1, 2001

Related U.S. Application Data
(60) Provisional application No. 60/208,847, filed on Jun. 2, 2000.

(51) Int. Cl. G06F 17/24

(52) U.S. Cl. 345/744; 345/760; 707/513

(57) ABSTRACT

Provision of persistent support and assistance to standard browser navigation is disclosed. Preferably, among compliant sites, a common look, feel, and/or functionality is provided. This will particularly assist novice users' navigation of the Internet, as the experience for compliant sites will be aligned with a familiar set of display and functional expectations. One disclosed feature implements a proprietary tag that can be embedded within a web page. The tag indicates whether the page and/or site is compliant with the persistent support features. Once this is understood, the browser can be appropriately instructed or updated to provide the persistent features. Another disclosed feature offers supplemental information regarding resources displayed on a current web page. The supplemental information is not merely additional information that may have been provided along with the current web page; rather, it is preferably information particular to the user. Thus, for example, consumer incentive information related to available resources and particularly associated to the user can be displayed, to further assist web navigation and enjoyment.

### CROSS REFERENCE TO RELATED APPLICATIONS

This application claims priority from U.S. Provisional Patent Application Ser. No. 60/208,847, filed Jun. 2, 2000.

### BACKGROUND OF THE INVENTION

1. Field of the Invention

This application relates generally to methods and apparatus for navigating among resources in a network environment and more particularly to methods and apparatus for providing assistance in navigating among Internet or web resources.

2. Description of the Related Art

One problem with conventional Internet navigation is that the look, feel and functionality of the many different sites available to the user can vary. This may not pose much of an obstacle for those having computer or web navigation savvy, but for the novice user, it may present a significant impediment and disincentive to using Internet resources.

Another problem, regardless of the experience level of the user, is that the user is often unaware of, or unable to manage, the various incentive programs and the like that may be available when navigating the Internet or when preparing to conduct transactions using the Internet.

### SUMMARY OF THE INVENTION

This invention provides a navigation assistance application that supports, assists and supplements standard navigation.

Preferably, the navigation assistance application provides a common look, feel and/or functionality, so that the novice user can navigate according to a familiar set of expectations. The assistant features can be user defined, or they can be provided to the user in default format. The latter would allow a service provider or the like to provide a look/feel/functionality platform for which users can develop an affinity or expectation.

In certain embodiments, the application can determine whether an accessed web site or page is compliant with the proprietary format driven by the application. This may be done by scanning the relevant page to determine whether it contains an embedded tag indicating such compliance. Various display features may be included in the proprietary format, and the presence of the format may be visually conveyed to the user, such as by displaying a familiar icon in a familiar location. In one assistance mode, the accessed web page is fully displayed in one frame, and an adjacent frame is used to provide supplemental information and navigation assistance. This allows the user to view the accessed page in a fashion similar to an ordinary user, but also maintains the persistent utility feature as desired.

Other embodiments of the invention may identify a particular resource displayed on a first web page and then determine whether an entry corresponding to the particular resource is contained in a database that correlates supplemental information to web resources. Supplemental information for the particular resource is displayed along with the first web page where it is determined that the database contains an entry for the particular resource. Thus, for example, the user may be informed of consumer incentives that are not generally manifest or found in a current web page, but which relate to a resource available in or from the web page, and which are indicated to be available to the user based at least in part on an examination of the database for the user.

### BRIEF DESCRIPTION OF THE DRAWINGS

These and other more detailed and specific features of the present invention are more fully disclosed in the following specification, reference being had to the accompanying drawings, in which:

FIG. 1 is a schematic diagram illustrating an exemplary computer system within which embodiments of navigation assistance may operate.

FIG. 2 is a block diagram illustrating an embodiment of a computer configured to include browsing with navigation assistance in accordance with the present invention.

FIG. 3 is a block diagram illustrating an embodiment of a navigation assistance application that provides a persistent navigation assistance module and/or a supplemental information module in accordance with the present invention.

FIG. 4 is a flow diagram illustrating the operation of an embodiment of the persistent navigation assistance module in accordance with the present invention.

FIG. 5 is a flow diagram illustrating the operation of an embodiment of the supplemental information module in accordance with the present invention.

### DETAILED DESCRIPTION OF THE INVENTION

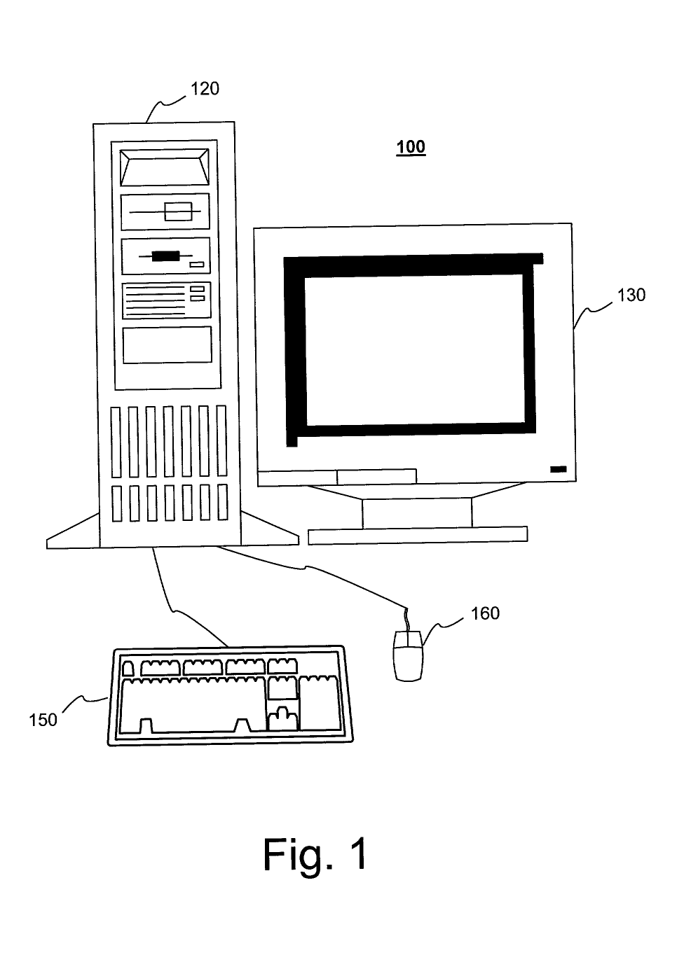

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention. The schematic diagram of FIG. 1 shows an embodiment of a computer system 100. The computer system 100 includes a main housing 120 connected to a monitor 130, keyboard 150, and mouse 160. The main housing 120 includes various items that are typically used in a computer system 100. By way of example, these elements may be a processor, ROM and RAM memory, cache memory, a hard disk storage device, a floppy disk drive, a storage tape drive, graphics and audio cards, a network interface card, and a power supply, all interconnected using a conventional architecture.

A computer system 100 configured as such provides visual output through a monitor 130 and audio output through speakers (not shown), and receives input through a keyboard 150, mouse 160, and microphone. The input can cooperate with the output in conventional fashion, such as wherein a computer user moves a cursor about a graphical display and provides input based upon the cursor location. For example, the user may use the mouse 160 to move a cursor over an icon for an application on the graphical display shown on the monitor 130, and may then use the mouse to double click on the icon to launch the application (cause it to be executed). Such interfacing between a computer and its user can be referred to as a graphical user interface.

Although the described computer system 100 is of the desktop type, it is noted that the present invention is equally applicable to other computer system types, such as lap tops, personal digital assistants (e.g. Palm™, as provided by Palm, Inc.), and wireless based systems (e.g. iMode™, as provided by NTT DoCoMo, Inc.). Additionally, although the preferred embodiment implements a mouse for moving a cursor and providing input, it is noted that various technologies for accepting input and displaying output will evolve, and that such evolving technologies are contemplated by the present invention. For example, instead of the mouse, audio commands may ultimately be used to cause a cursor to move about a display, etc. These and other alternatives will be recognized by the ordinarily skilled artisan.

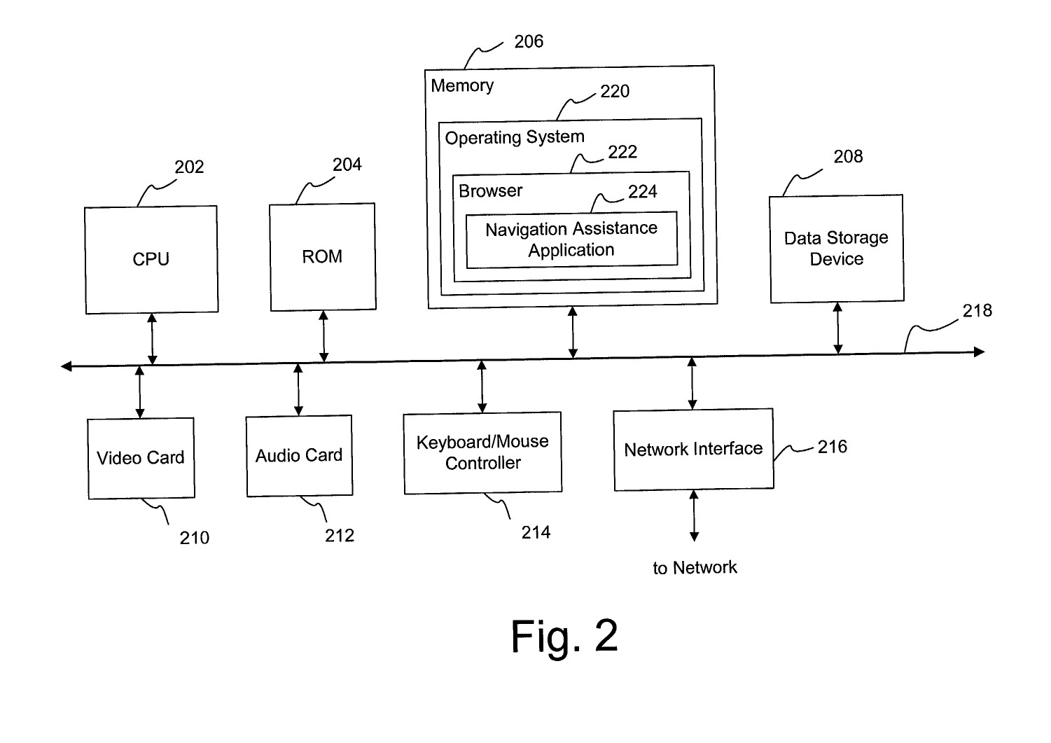

The block diagram of FIG. 2 illustrates an embodiment of a computer 200 (the portion of the system 100 typically found in the main housing 120) that includes a CPU 202, ROM 204, memory 206, data storage device 208, video card 210, audio card 212, keyboard/mouse controller 214, and network interface 216, each coupled to a bus 218 in conventional fashion. The CPU 202 is a conventional processor, such as the PENTIUM™ type provided by Intel Corporation of Santa Clara, Calif. The CPU 202 executes instructions, such as those provided in ROM 204 and/or memory 206. ROM 204 is a read only memory, which retains its stored information even while it is disconnected from a power supply. The ROM 204 may, for example, store instructions for a boot up sequence. Memory 206 is preferably volatile memory for storing instructions and information used during ordinary operation, such as those provided in the computer operating system. The data storage device 208 provides long term data storage, and is preferably a magnetic or magneto-optic hard disk device. The video card 210 and audio card 212 respectively provide the interface between the computer 200 and the monitor and speakers. The keyboard mouse controller 214 provides an interface between the computer 200 and the keyboard and mouse that are used to provide input to the computer 200. The network interface 216 is a conventional network interface card that interfaces a local network line and the computer 200. The network interface card may be a conventional ethernet card, or may be a multipurpose interface for communication over a ethernet, ISDN and/or other networks. Access to the Internet can be provided through the network interface 216.

It is noted that a computer 200 may include different items than those noted in the described embodiment. For example, I/O ports for interfacing with printers and plotters, a floppy disk drive, a CD ROM drive, and various other features may be included, and various elements may be excluded. Also, although Internet access is described in connection with a network interface card, a modem connected to a conventional phone line can be used to access the Internet, such as through an internet service provider. The ordinarily skilled artisan will recognize the various alternatives for the computer 200.

Still referring to FIG. 2, the memory 206 also includes an operating system 220, browser 222 and navigation assistance application 224. The operating system 220 is a program that is typically loaded from the long term data storage device 208 (e.g., hard disk) to the main memory 206 during a boot up sequence. The operating system 220 manages the other programs in the computer, which are referred to as applications, and includes particular instructions and operations that can be used by the applications, either directly or through an application program interface. The operating system 220 also handles exchanges to and from devices connected to the computer (e.g., printers, disk drives, etc.), manages memory use, and allocates computing resources in multitasking environments. Preferably, the operating system 220 is WINDOWS95 or WINDOWS98, as provided by Microsoft, Inc. of Redmond, Wash.

The browser 222 includes instructions for displaying information, for linking to other information, and for transferring information to and from the computer 200. For example, the browser 222 includes instructions for displaying web pages using HTML, and transfers information using HTTP. Preferably, the browser 222 is the INTERNET EXPLORER, as provided by Microsoft. Various alternative browsers, such as the NAVIGATOR, as provided by Netscape, Inc. can be provided. Although the browser 222 is shown as an application operating within the management of the operating system 220, it may alternatively be an integrated part of the operating system 220.

The navigation assistance application 224 is an application that includes executable instructions and information for providing navigation assistance including persistent navigation assistance and provision of supplemental information regarding available web resources, in accordance with the present invention. Preferably, the navigation assistance application 224 operates in conjunction with the browser 222, and may invoke the browser to provide certain aspects found in embodiments of the present invention. The navigation assistance application 224 may also be provided as an integrated portion of the browser 222. Generally, the navigation assistance application 224 supports and assists standard navigation, preferably providing a common look, feel and/or functionality during Internet or World Wide Web (“web”) navigation. The assistant features can be user defined, or they can be provided to the user in default format, which would allow development of an affinity building common experience platform.

In one aspect, the navigation assistance application 224 provides the common look and functionality for pages that conform with a proprietary standard. Preferably, the application 224 examines web pages for the presence of a particular HTML tag or identifier, which would be indicative of a page compatible with the navigation assistance features. Pages having the particular tag could thus be said to be “navigation assistant ready.” Upon access, the browser initially examines the page to determine whether it includes the particular tag. Non-compliant pages would be displayed just as they would using any conventional browser. Compliant pages would be displayed according to the preset common look, feel, and/or functionality of the navigation assistant. Accordingly, for example, the logo corresponding to the entity associated with the navigation assistant can be persistently displayed in a predictable location (either in a single page, or in a particular frame being displayed by the browser), particular music can be played in the background, and particular functionality can be associated with the page. Additionally, particular inputs (keystroke, mouse, etc.) might produce particular responses within the displayed page—responses which would not ordinarily be provided with a non-compliant page. In this fashion, particular background, color selections, locations of objects, and navigation features are implemented as new and different pages are accessed, in a persistent fashion.

Conformity to the navigation assistance format could also be indicated in hyperlinks. Thus, for example, the link to a page could be highlighted in a different color to indicate that it conforms with the format, or a message indicating the same could be displayed when the cursor is rolled over the link. Either of these scenarios could be implemented using conventional HTML programming techniques. For example, the browser can be invoked to investigate pages corresponding to links in the background, without requiring loading and/or displaying the entire target page. The navigation assistance application 224 can then update the color definitions for those links that conform, or can associate the appropriate message with conforming links, and monitor for the rollover condition that would trigger the display of the message.

The navigation assistance application 224 may also provide customized displays and behaviors that are not typically found during ordinary browsing. For example, in addition to navigating based upon traditional left mouse button clicks, a special input button on the mouse might link to navigation assistant resources. The special input button could be something as simple as the right mouse button, or may be another button or any means of input indication. It could also be activated to provide additional information merely upon rollover (this would not require depression of any mouse input button).

Another aspect of the navigation assistance application 224 is its provision of information supplemental to that displayed on a web page. The supplemental information is not merely additional information that may have been provided along with the current web page, such as detailed link information that may appear along the bottom of a browser display window upon hyperlink rollover; rather, it is preferably information stored separately from the web page, and information that is particularized to the user. Typically, the information will be provided in a local database that associates identifiable web resources to various supplemental information. Thus, for example, consumer incentive information related to available resources and particularly associated to the user can be displayed, to further assist web navigation and enjoyment.

In operation, the navigation assistance application 224 might determine what the cursor overlays, or what is on a displayed page, and then provide supplemental information about the corresponding resource. For example, a banner having a corresponding link may be displayed. Without needing to navigate to the site by clicking on it with the left mouse button, the navigation assistant can provide and display information such as (1) whether the corresponding site is approved for access, (2) what the access history is (e.g., has the user or another user of the browser accessed this site already?), and (3) whether any consumer incentives (strategic partnerships, discounts, etc.) relating to the site and the user are available (e.g., the site might provide a discount for holders of a particular credit card known to be held by the user.) The Assistant includes a database of particular user information, as well as default and historical navigation information to provide a foundation for the above functionality.

The navigation assistance application 224 can conventionally scan the code corresponding to the displayed page, such as by lexical stream scanning and analysis of the characters found in the code and/or page, and use conventional database indexing, searching and retrieving techniques for identifying sites or other resources, and providing the corresponding additional information. Of course, the navigation assistance application 224 may also implement non-local resources relating to pages and sites as well. For example, where the assistant includes a persistent frame, it might scan the navigated page, identify items within it, and provide links to additional information. Thus, if a particular product is displayed, the navigation assistance application 224 might provide links (in the frame) to locations that sell the product. The identified links are preferably stored locally or in defined, limited locations (i.e., the assistant does not merely search the web, it rather searches a proprietary database to identify the links corresponding to the product).

In one preferred alternative for displaying supplemental information, the navigation assistance application 224 displays a revised web page comprising a first frame and a second frame, where the first frame displays a web page as it would ordinarily be displayed, and a second frame, adjacent to the first frame, persistently displays navigation information that is supplemental to that displayed on the ordinary web page. This allows the user to see the web page in the first frame, in a fashion substantially identical to how the web page would be seen by a party not implementing the navigation assistance application 224, but also allows the user to avail themselves of the supplemental information in the second frame, in a convenient location. In still another aspect, the navigation assistance application 224 provides a set of functions that can be used as a common platform for providing compliant pages. For example, in XML implementations, a particular set of predefined functions form a set of commands used in developing navigation assistant compliant sites and pages. These functions would provide a particular look, and, significantly, particular responses to a user's navigation commands that would be predictable in any compliant page. The set of XML functions could be downloaded periodically for necessary updates.

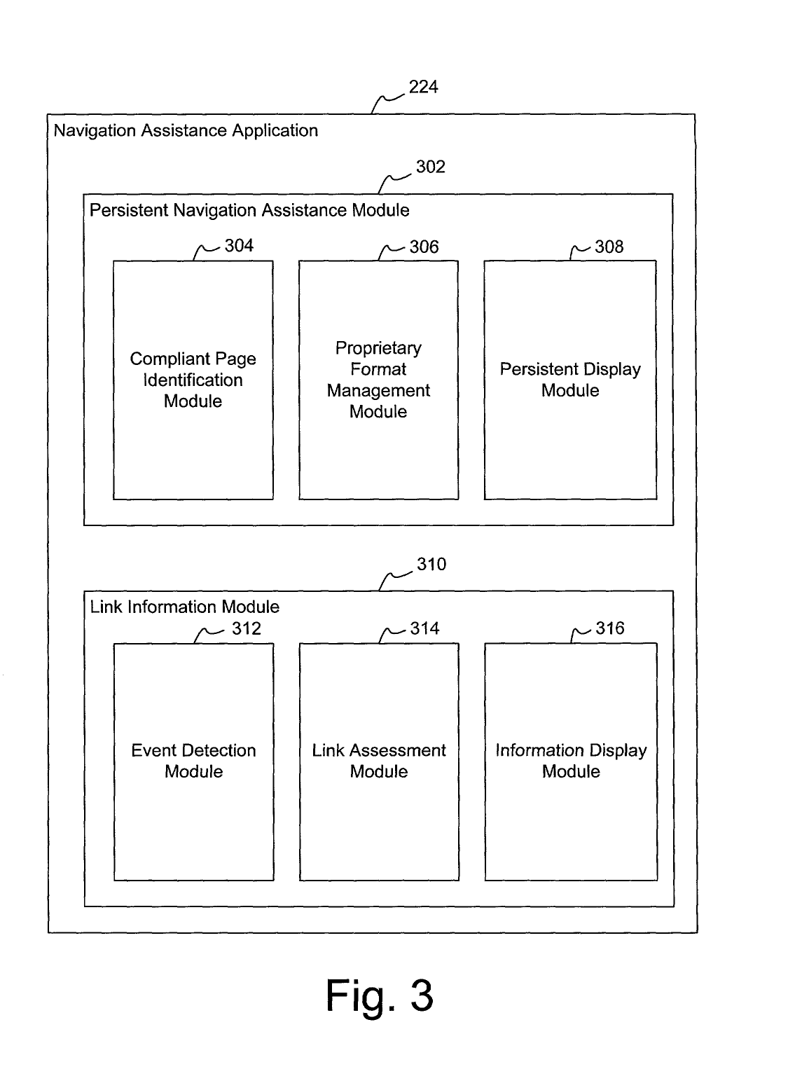

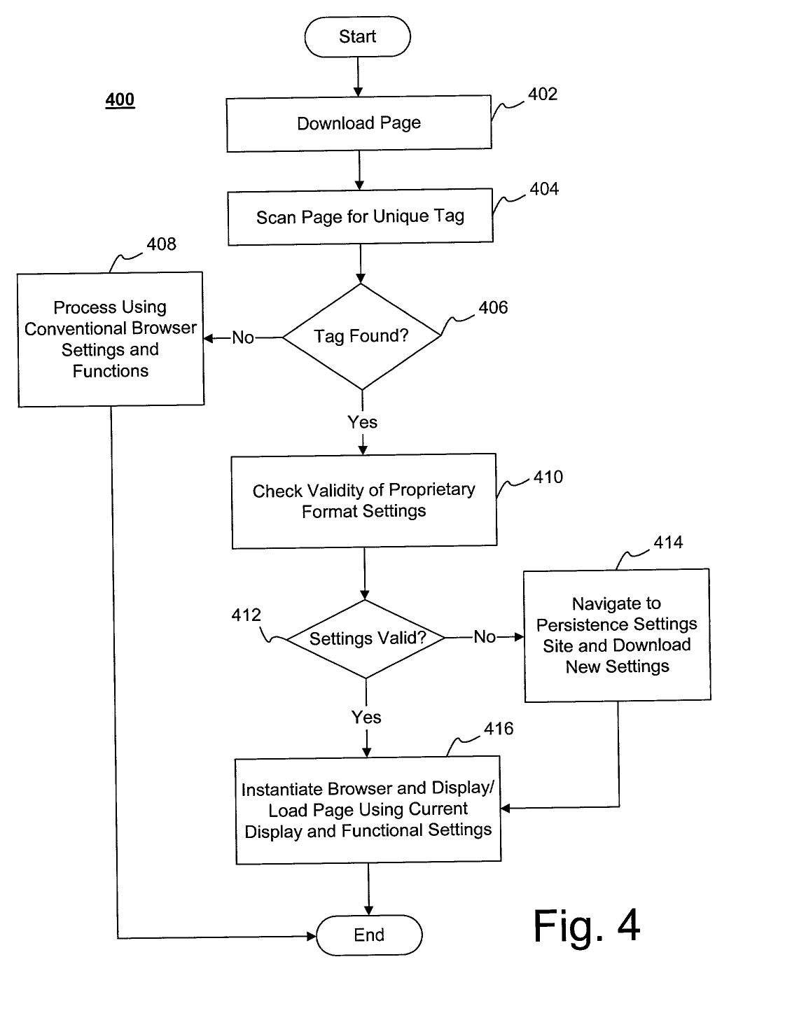

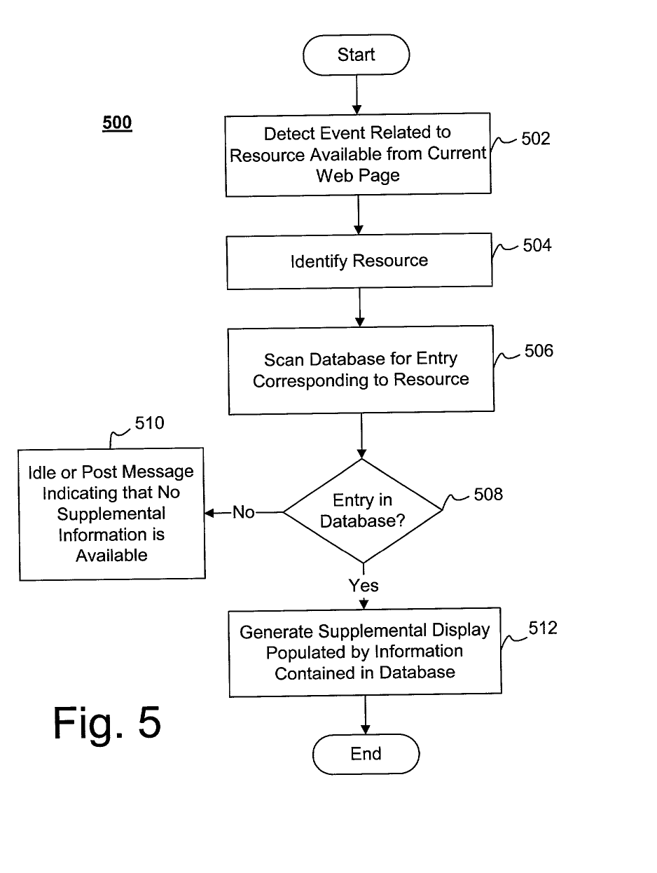

Referring now to the block diagram of FIG. 3, an embodiment of a navigation assistance application 224 consistent with the present invention includes a persistent navigation assistance module 302 and a supplemental information module 310. Preferably, these modules are provided as software, but they could be provided as hardware, firmware, or any combination of software, hardware and firmware. These modules 302, 310 store instructions that, when executed, can cause the computer system (e.g., 100, FIG. 1) to provide the various persistent navigation and supplemental information functionality described herein. Certain submodules of these modules 302, 310 and the flow diagrams of FIGS. 4 and 5 offer additional description of one embodiment of the present invention.

Referring first to the persistent navigation assistance module 302, disclosed therein are a compliant page identification module (CPIM) 304, proprietary format management module 306, and persistent display module 308. Generally, the CPIM 304 stores the HTML tag or other identifier that indicates web page conformity or compliance with the proprietary format, scans the subject web page to determine whether the page contains the identifier, such as by lexical stream based scanning, and indicates to other modules whether the page is compliant. The persistent display module 308 receives this indication and then displays the web page in conformity with the proprietary format. This may include the previously described two frame arrangement, where the original or ordinary web page resides in the first frame, and the second frame resides adjacent to the first frame and displays persistent navigation assistance information, which may also include supplemental information. The persistent display module 308 may invoke the browser to create the multiple frame environment. Alternatively, the persistent display module 308 may create an instance of the browser in addition to the instance used to display the original web page, with a display of the persistent navigation assistance information in a second (e.g. pop up) browser window. The persistent navigation assistance may include a particular logo to identify the window, frame, or portion of the display as the navigation assistant, may include links to generally helpful information, may invoke the audio player to cause particular music to be played (in the absence of sound requests from the ordinary web page), and may also include supplemental information (described previously, and below). These features may be incorporated using conventional programming languages (e.g. HTML and XML) and techniques.

The proprietary format management module 306 manages the proprietary format used by the persistent display module 308. Generally, the settings for the format are stored by the proprietary format management module 306, or memory or storage device connected thereto. These settings might include a definition or pointer to the logo or icon to be displayed in the persistent navigation assistant display region, particular colors, or particular functions (e.g. a set of XML based functions). Additionally, a validity period may also be associated with the proprietary format. Thus, when the persistent display module 308 tries to invoke the current format, upon indication of a compliant page, the proprietary format management module 306 might check the validity of the current format. For example, the current format might have an associated expiration date that can be checked against calender information stored in the computer system, or maintained by the module itself. If the proprietary format has expired or is otherwise invalid, the proprietary format management module 306 updates the format to reinstate its validity. Preferably, this is accomplished by background navigation to a particular web site, designated in the module 306, and then downloading the new settings, or merely getting indication that the current format can remain valid.

FIG. 4 illustrates the operation of an embodiment of the persistent navigation assistance module 302 in accordance with the present invention. An ordinary web page is downloaded (402) preferably through an instance of a conventional browser, and is then scanned (404) for the presence of the identifier that indicates proprietary format compliance. This can be accomplished by scanning the contents of the web page to determine (406) whether they contain the string corresponding to the identifier, or scanning for a field and checking to see whether the corresponding value indicates compliance, or via various other techniques. Where the identifier is not found, the web page is processed (408) using the conventional browser functions and settings. Where the identifier is found, the validity of the proprietary format is checked (410) to determine (412) whether the format remains valid. Where the format has become invalid, the method navigates (414) to a web site to download new settings for the proprietary format, to reinstate its validity. The browser is invoked as needed, and the web page is then displayed (416) using the proprietary format.

Referring again to FIG. 3, the supplemental information module 310 comprises an event detection module 312, a link assessment module 314, and a supplemental information display module 316. The event detection module 312 monitors for an event relating to a resource displayed on a displayed web page, and in turn prompts the remaining modules 314, 316 to ultimately display supplemental information for the resource. The link assessment module identifies the resource displayed on the web page and determines whether an entry for the resource is located in a database the correlates supplemental information to each of several potential resources. This database would not be part of the original web page, and the supplemental information would not be part of the original web page; rather, the supplemental information would be found in a local database, separate from the web page. The supplemental information display module 316 receives an indication that an entry in the supplemental information database has been found for the resource, and displays supplemental information for the resource along with the original web page.

Referring now to the flow diagram of FIG. 5 along with FIG. 3, the operation of an embodiment of the supplemental information module 310 is further described. Initially, a “current” web page has been downloaded and is displayed for the user. An event related to a resource available from the current web page is detected (502). For example the event detection module 312 may detect the presence of the cursor over a hyperlink, using conventional techniques. There, the resource is represented by the hyperlink, and the event is the detection of rollover relative to the hyperlink. Various other events could easily be detected, such as a mouse right button click, etc., and are certainly contemplated by the present invention. Additionally, an event might be the invocation of a full supplemental information frame, window or display section, as described regarding persistent navigation assistance module (302, FIG. 3) above.

Next, the resource is identified (504) and the database is scanned (506) to determine (508) whether an it contains an entry corresponding to the resource. In one example, the characters for the link may be obtained, and a column in a table in the database may be queried to determine whether it contains a relevant entry. More particularly, the link may include the string “. . . Sonystyle . . .”, among other things. The database column for vendor might include references to various web sites (e.g. Amazon™, Sony™, Sonystyle™, etc.). These values may be sequentially examined to see whether a matching string exists in the link. A match dictates the presumption that the web resource, here the hyperlink, has the corresponding entry in the database.

If there is no entry in the database, the supplemental information module 310 acts accordingly. That is, it may either idle or post a message (510) indicating that no supplemental information is available. If there is a matching entry, then the supplemental information module 310 generates a supplemental display populated by information contained in the database. Continuing further with the above described example, the entry for “Sonystyle” may correlate to additional columns in the database data table for various cross relations, that are preferably suited to the user. Accordingly, the database might also indicate that the user has a Sony MasterCard™ and that the Sonystyle™ web site is currently providing a consumer incentive to use the two together. Thus, the supplemental information module 310 would include in the displayed supplemental information, a message such as “If you use your Sony MasterCard™ to purchase Sony™ products online from the Sonystyle™ web site, you will enjoy a 10% discount and free shipping on all purchases prior to [Date].”

In addition to web sites, the web resource may denote products. For example, a complex string such as “. . . sonystyle.com/sonystyle/4784/5626/5645/21.trans.html . . . ” might be detected and matched to a local database entry for a particular page in the Sonystyle™ web site, which might correspond to Sony Trinitron™ televisions. There, a message tailored to these specific products, based upon additional information contained in the database might be provided. For example, the database may also include information about the user's current home consumer electronics system. Thus, it may indicate, for example, that the user has a General Electric™ 19 inch television purchased in 1985. It may further indicate that Sony™ is offering a discount to owners of competing television sets. Here, the message may indicate “Sony is currently offering a 10% discount to owners of General Electric™ television sets. You may want to replace your existing set with a new 27″ Sony Trinitron™ model. Better, yet, if you use your Sony MasterCard™ to purchase Sony™ products online from the Sonystyle™ web site, you will enjoy an additional 10% discount and free shipping on all purchases prior to [Date].”

As described above, these messages may overlay the original web page, near the subject hyperlink. They may further be displayed semi-transparently, so as not to obscure the web page, using programming techniques. Additionally, again as described above, the messages may be visually separated from the original web page, such as in a separate frame or a pop up browser instance.

Thus, methods and apparatus for navigation assistance are provided in accordance with the present invention. Although the present invention has been described in considerable detail with reference to certain embodiments thereof, other embodiments are possible. For example, although one embodiment may modularize the software contained in the navigation assistance application as shown in FIG. 3, more or less modules may be provided for a similar overall functionality. Therefore, the sprit and scope of the appended claims should not be limited to the description of the preferred embodiments contained herein.

1. A method for displaying the contents of web pages, the method comprising:
downloading a web page;
scanning the web page to determine whether the web page includes an identifier that indicates that the web page is compliant with a proprietary format that differs from a default browsing format, the proprietary format including a particular display characteristic; and
upon determination that the web page includes the identifier, displaying the web page in conformity with the proprietary format.

2. The method of claim 1, wherein the particular display characteristic includes a display of an icon corresponding to an entity associated with the proprietary format.

3. The method of claim 2, wherein the proprietary format provides an enhanced web page display having a first frame and a second frame, the first frame displaying the web page according to the default browsing format, the second frame residing adjacent to the first frame and displaying supplemental information about a resource available from the web page.

4. The method of claim 1, further comprising:
prior to displaying the web page in conformity with the proprietary format, determining the validity of the proprietary format; and
where it is determined that the proprietary format is no longer valid, navigating to a web site that updates the proprietary format and reinstates the validity of the proprietary format.

5. An apparatus for displaying the contents of web pages, the apparatus comprising:
a browsing module, for downloading a web page;
an identification module, in communication with the browsing module, for scanning the web page to determine whether the web page includes an identifier that indicates that the web page is compliant with a proprietary format that differs from a default browsing format, the proprietary format including a particular display characteristic; and
a display management module, in communication with the identification module, for displaying the web page in conformity with the proprietary format upon determination that the web page includes the identifier.

6. The apparatus of claim 5, wherein the particular display characteristic includes a display of an icon corresponding to an entity associated with the proprietary format.

7. The apparatus of claim 6, wherein the proprietary format provides an enhanced web page display having a first frame and a second frame, the first frame displaying the web page according to the default browsing format, the second frame residing adjacent to the first frame and displaying supplemental information about a resource available from the web page.

8. The apparatus of claim 5, further comprising:
a proprietary format management module, for determining the validity of the proprietary format prior to the display of the web page in conformity with the proprietary format, and for navigating to a web site that updates the proprietary format where it is determined that the proprietary format is no longer valid.

9. An apparatus for displaying the contents of web pages, the apparatus comprising:
means for downloading a web page; and
means for scanning the web page to determine whether the web page includes an identifier that indicates that the web page is compliant with a proprietary format that differs from a default browsing format, the proprietary format including a particular display characteristic; and
means for displaying the web page in conformity with the proprietary format upon determination that the web page includes the identifier.

10. The apparatus of claim 9, wherein the particular display characteristic includes a display of an icon corresponding to an entity associated with the proprietary format.

11. The apparatus of claim 10, wherein the proprietary format provides an enhanced web page display having a first frame and a second frame, the first frame displaying the web page according to the default browsing format, the second frame residing adjacent to the first frame and displaying supplemental information about a resource available from the web page.

12. The apparatus of claim 9, further comprising:
means for determining the validity of the proprietary format prior to the display of the web page in conformity with the proprietary format, and for navigating to a web site that updates the proprietary format where it is determined that the proprietary format is no longer valid.

13. A computer readable storage medium that stores instructions for performing the steps of:
downloading a web page;
scanning the web page to determine whether the web page includes an identifier that indicates that the web page is compliant with a proprietary format that differs from a default browsing format, the proprietary format including a particular display characteristic; and
displaying the web page in conformity with the proprietary format upon determination that the web page includes the identifier.

14. The computer readable storage medium of claim 13, wherein the particular display characteristic includes a display of an icon corresponding to an entity associated with the proprietary format.

15. The computer readable storage medium of claim 14, wherein the proprietary format provides an enhanced web page display having a first frame and a second frame, the first frame displaying the web page according to the default browsing format, the second frame residing adjacent to the first frame and displaying supplemental information about a resource available from the web page.

16. The computer readable storage medium of claim 13, further including instructions for performing the step of:
determining the validity of the proprietary format prior to the display of the web page in conformity with the proprietary format, and for navigating to a web site that updates the proprietary format where it is determined that the proprietary format is no longer valid.

17. A method for displaying supplemental information regarding displayed web pages for a user, the method comprising:
identifying a particular resource displayed on a first web page;
determining whether an entry corresponding to the particular resource is contained in a database that correlates supplemental information to each of a plurality of resources, wherein the database is separate from the first web page and the first web page is ordinarily devoid of the supplemental information; and
displaying supplemental information for the particular resource along with the first web page where it is determined that the database contains an entry for the particular resource.

18. The method of claim 17, wherein the particular resource is a link to a second web page.

19. The method of claim 18, wherein the second web page correlates to a purchasable item, and the supplemental information includes a consumer incentive available to the user and relating to the purchasable item, the consumer incentive being obtained from the database and not being ordinarily evident from the web page.

20. The method of claim 19, wherein the consumer incentive is a discount for purchasing the purchasable item from the web site using a particular credit card, the database includes an entry indicating that the user has the particular credit card, and the supplemental information indicates that the user will obtain the consumer incentive where the particular credit card is used to purchase the purchasable item.

21. The method of claim 17, further comprising:
detecting an event relating to the particular resource, wherein the event prompts the display of supplemental information for the particular resource.

22. The method of claim 21, wherein the event is a cursor rollover of the particular resource, and the supplemental information is superimposed on the first web page in the vicinity of the display of the particular resource.

23. An apparatus for displaying supplemental information regarding displayed web pages for a user, the apparatus comprising:
a link assessment module, for identifying a particular resource displayed on a first web page and determining whether an entry corresponding to the particular resource is contained in a database that correlates supplemental information to each of a plurality of resources, wherein the database is separate from the first web page and the first web page is ordinarily devoid of the supplemental information; and
a supplemental information display module, in communication with the link assessment module, for displaying supplemental information for the particular resource along with the first web page where it is determined that the database contains an entry for the particular resource.

24. The apparatus of claim 23, wherein the particular resource is a link to a second web page.

25. The apparatus of claim 24, wherein the second web page correlates to a purchasable item, and the supplemental information includes a consumer incentive available to the user and relating to the purchasable item, the consumer incentive being obtained from the database and not being ordinarily evident from the web page.

26. The apparatus of claim 25, wherein the consumer incentive is a discount for purchasing the purchasable item from the web site using a particular credit card, the database includes an entry indicating that the user has the particular credit card, and the supplemental information indicates that the user will obtain the consumer incentive where the particular credit card is used to purchase the purchasable item.

27. The apparatus of claim 23, further comprising:
an event detecting module, for detecting an event relating to the particular resource, wherein the event prompts the display of supplemental information for the particular resource.

28. The method of claim 27, wherein the event is a cursor rollover of the particular resource, and the supplemental information is superimposed on the first web page in the vicinity of the display of the particular resource.

29. An apparatus for displaying supplemental information regarding displayed web pages for a user, the apparatus comprising:
means for identifying a particular resource displayed on a first web page and determining whether an entry corresponding to the particular resource is contained in a database that correlates supplemental information to each of a plurality of resources, wherein the database is separate from the first web page and the first web page is ordinarily devoid of the supplemental information; and
means for displaying supplemental information for the particular resource along with the first web page where it is determined that the database contains an entry for the particular resource.

30. The apparatus of claim 29, wherein the particular resource is a link to a second web page.

31. The apparatus of claim 30, wherein the second web page correlates to a purchasable item, and the supplemental information includes a consumer incentive available to the user and relating to the purchasable item, the consumer incentive being obtained from the database and not being ordinarily evident from the web page.

32. The apparatus of claim 31, wherein the consumer incentive is a discount for purchasing the purchasable item from the web site using a particular credit card, the database includes an entry indicating that the user has the particular credit card, and the supplemental information indicates that the user will obtain the consumer incentive where the particular credit card is used to purchase the purchasable item.

33. The apparatus of claim 29, further comprising:
means for detecting an event relating to the particular resource, wherein the event prompts the display of supplemental information for the particular resource.

34. The method of claim 33, wherein the event is a cursor rollover of the particular resource, and the supplemental information is superimposed on the first web page in the vicinity of the display of the particular resource.

35. A computer readable storage medium that stores instructions for performing the steps of:
identifying a particular resource displayed on a first web page and determining whether an entry corresponding to the particular resource is contained in a database that correlates supplemental information to each of a plurality of resources, wherein the database is separate from the first web page and the first web page is ordinarily devoid of the supplemental information; and
displaying supplemental information for the particular resource along with the first web page where it is determined that the database contains an entry for the particular resource.

36. The computer readable storage medium of claim 35, wherein the particular resource is a link to a second web page.

37. The computer readable storage medium of claim 36, wherein the second web page correlates to a purchasable item, and the supplemental information includes a consumer incentive available to the user and relating to the purchasable item, the consumer incentive being obtained from the database and not being ordinarily evident from the web page.

38. The computer readable storage medium of claim 37, wherein the consumer incentive is a discount for purchasing the purchasable item from the web site using a particular credit card, the database includes an entry indicating that the user has the particular credit card, and the supplemental information indicates that the user will obtain the consumer incentive where the particular credit card is used to purchase the purchasable item.

39. The computer readable storage medium of claim 35, further comprising instructions for performing the step of:
detecting an event relating to the particular resource, wherein the event prompts the display of supplemental information for the particular resource.

40. The method of claim 39, wherein the event is a cursor rollover of the particular resource, and the supplemental information is superimposed on the first web page in the vicinity of the display of the particular resource.
